(19) United States
(12) Patent Application Publication
(10) Pub. No.: US 2026/0287322 A1
(43) Pub. Date: Sep. 24, 2026

(54) ELECTRIC ACTUATOR AND ASSEMBLY WITH DUAL FUNCTIONS OF STRAIN SENSING AND DAMPING MECHANISM THEREOF

(71) Applicant: TIMOTION TECHNOLOGY CO., LTD., New Taipei City (TW)

(72) Inventor: Yi-Fu CHEN, New Taipei City (TW)

(21) Appl. No.: 19/207,004

(22) Filed: May 13, 2025

(30) Foreign Application Priority Data
Mar. 19, 2025 (TW) 114110331

(51) Int. Cl. G01B 7/16; F16F 7/08

(52) U.S. Cl. CPC G01B 7/16; F16F 7/087; F16F 2224/025; F16F 2230/0029; F16F 2238/04

(57) ABSTRACT

An assembly with dual functions of strain sensing and damping mechanism includes: a load body having a columnar member and a flange extended from the columnar body, the columnar member has an opening, and two opposite sides of the opening are disposed with detected surfaces; strain sheets attached on the detected surfaces to sense a deforming level of the detected surface; a cable connector having a connection head and a cable, the connection head is connected to the columnar member, and the cable passes the connection head to be electrically connected to the strain sheets; and an impact absorbing unit disposed on an end surface of the flange to absorb an impact force applied to the load body. Accordingly, an applied force detecting function is provided.

### BACKGROUND OF THE DISCLOSURE

### Technical Field

The present disclosure relates to an electric actuator, especially to an electric actuator and an assembly with dual functions of strain sensing and damping mechanism thereof.

### Description of Related Art

A related-art electric actuator has been commonly applied in various fields and instruments, for example an industrial field, a medical field, a domestic bed, a massage chair, a rehabilitation instrument, a door opener, a window opener and an elevation mechanism. The electric actuator is used to push an object with a light to an extremely heavy weight for a lifting or an angle changing operation. The related-art electric actuator utilizes a motor to work with a transmission mechanism and a deceleration mechanism to drive a lead screw to rotate, and the lead screw drives the actuator screwed with the lead screw to perform a linear protruding or retracting action.

However, the electric actuator has a loading limit, and the loaded weight may not be measured by most of the electric actuators. For the electric actuators applied in the industrial field or the agricultural field, the loaded weight is very heavy and often exceeds the loading limit of the electric actuator, thus the actuator or other mechanisms may be deformed and damaged. For preventing the aforesaid situations from happening, a strain meter is disposed on the electric actuator, signal wires of the strain meter are layout inside the electric actuator, thus the strain meter is not easy to be installed or detached, and the strain meter may not be replaced according to the requirements of a user, and another software, instead of the software authorized by the designing company, may not be used for processing a detecting operation.

Accordingly, the applicant of the present disclosure has devoted himself for improving the mentioned shortages.

### SUMMARY OF THE DISCLOSURE

The present disclosure provides an electric actuator and an assembly with dual functions of strain sensing and damping mechanism thereof, which have advantages of providing a supplied force sensing function and an effect of preventing components and mechanism from being damaged due to an accidental impact.

Accordingly, the present disclosure provides an assembly with dual functions of strain sensing and damping mechanism, which includes a load body, a pair of strain sheets, a cable connector and an impact absorbing unit; the load body has a columnar member and a flange extended from the columnar body, the columnar member has an opening; and two opposite sides of the opening are disposed with a pair of detected surfaces; each of the strain sheets is attached on each of the detected surfaces to sense a deforming level of each of the detected surfaces; the cable connector includes a connection head and a cable, the connection head is connected to the columnar member, and the cable passes the connection head to be electrically connected to each of the strain sheets; the impact absorbing unit is disposed on an end surface of the flange to absorb an impact force applied to the load body.

Accordingly, the present disclosure provides an electric actuator, which includes a gear box, a motor, a deceleration mechanism, a transmission mechanism and an assembly with dual functions of strain sensing and damping mechanism; the motor is connected to the gear box; the transmission mechanism is connected to the gear box and disposed at one lateral side of the motor, the transmission mechanism is driven by the motor; the assembly with dual functions of strain sensing and damping mechanism is disposed at one side of the gear box opposite to the transmission mechanism and includes a load body, a pair of strain sheets, a cable connector and an impact absorbing unit, the load body has a columnar member and a flange extended from the columnar body, the columnar member has an opening, and two opposite sides of the opening are disposed with a pair of detected surfaces; each of the strain sheets is attached on each of the detected surfaces to sense a deforming level of each of the detected surfaces, the cable connector includes a connection head and a cable, the connection head is connected to the columnar member, and the cable passes the connection head to be electrically connected to each of the strain sheets; the impact absorbing unit is disposed on an end surface of the flange to absorb an impact force applied to the load body.

In comparison with related art, the present disclosure has advantageous features as follows. Vibrations generated due to external forces or operation processes are effectively reduced, thus the service life is prolonged, and the operation stability is ensured. With the strain sheet, a wight loaded on the actuator is detectable, a force applying change is immediately sensed during the actuation process, thus the system precisely controls the applied force, and the operation safety is enhanced. When an excessive force is detected, the system immediately adjusts or stops the operation or even makes the operation reverse to prevent any accident from happening. With a polygonal slot hole of the load body and a polygonal segment of the connection being assembled, the load body and the connection head are limited to axially move. With a self-lubricating sleeve shaft, a lubricating effect is provided when the load body and the connection head axially move to ensure the operation smoothness.

### BRIEF DESCRIPTION OF THE DRAWINGS

FIG. 1 is a perspective view showing the assembly of the electric actuator according to the present disclosure;

FIG. 2 is an exploded view showing the assembly with dual functions of strain sensing and damping mechanism and the gear box according to the present disclosure;

FIG. 3 is an exploded view showing the assembly with dual functions of strain sensing and damping mechanism according to the present disclosure;

FIG. 4 is a cross-sectional view showing the assembly of the electric actuator according to the present disclosure;

FIG. 5 is a cross-sectional view showing an operating status of the electric actuator being applied with a push force according to the present disclosure; and

FIG. 6 is a cross-sectional view showing an operating status of the electric actuator being applied with a pull force according to the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

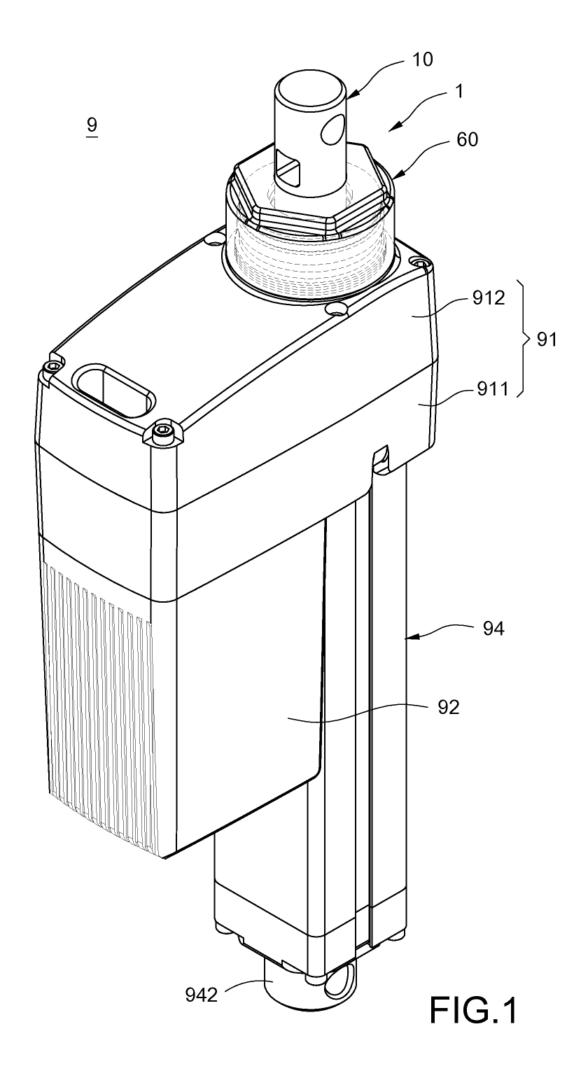

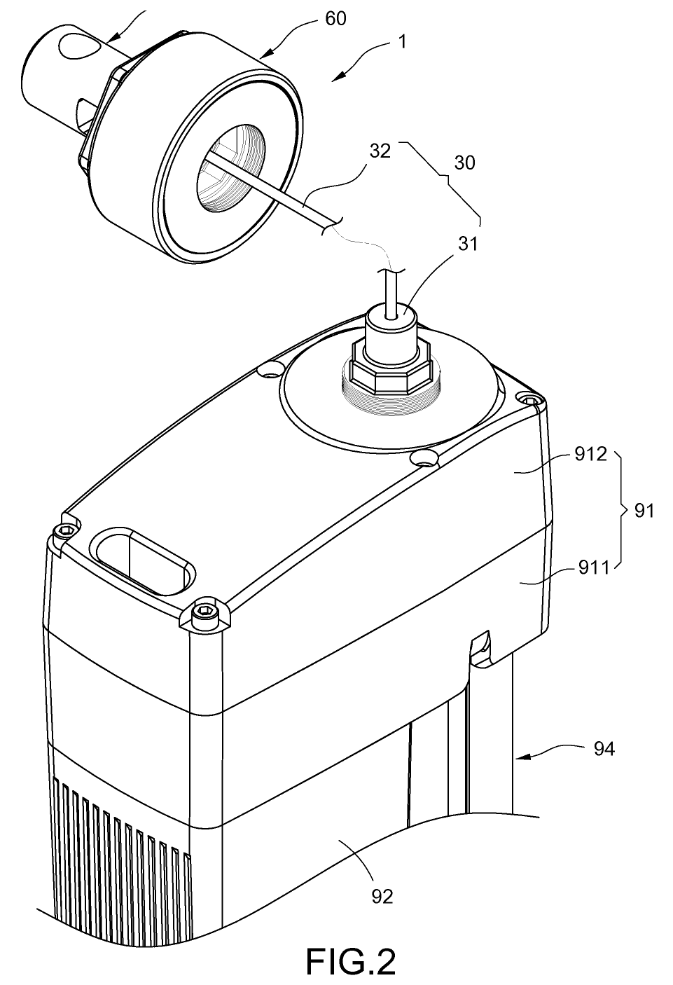

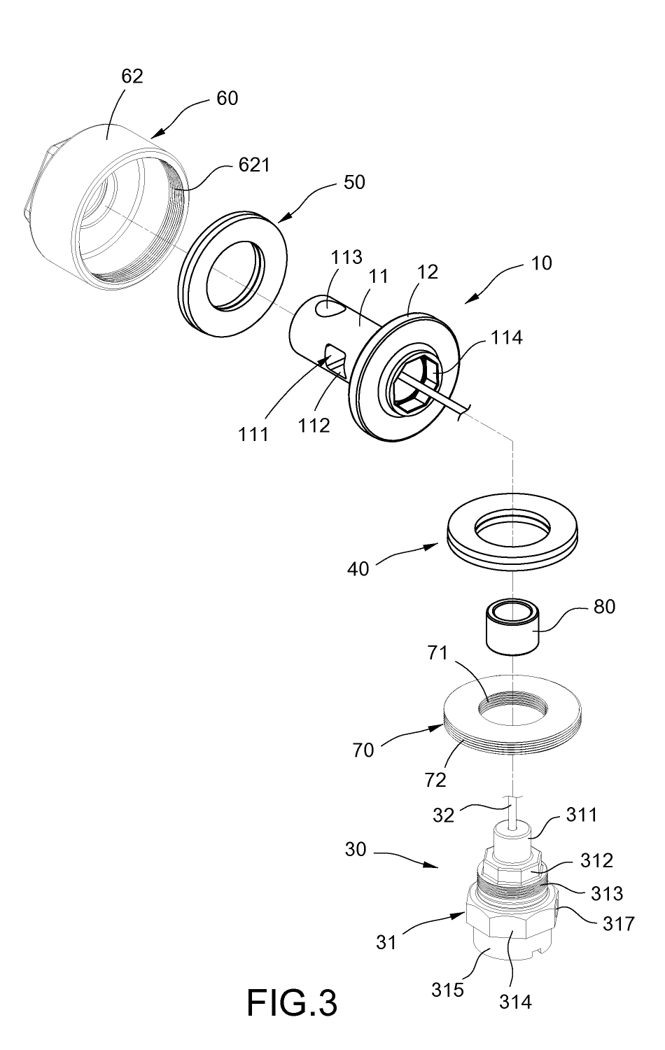

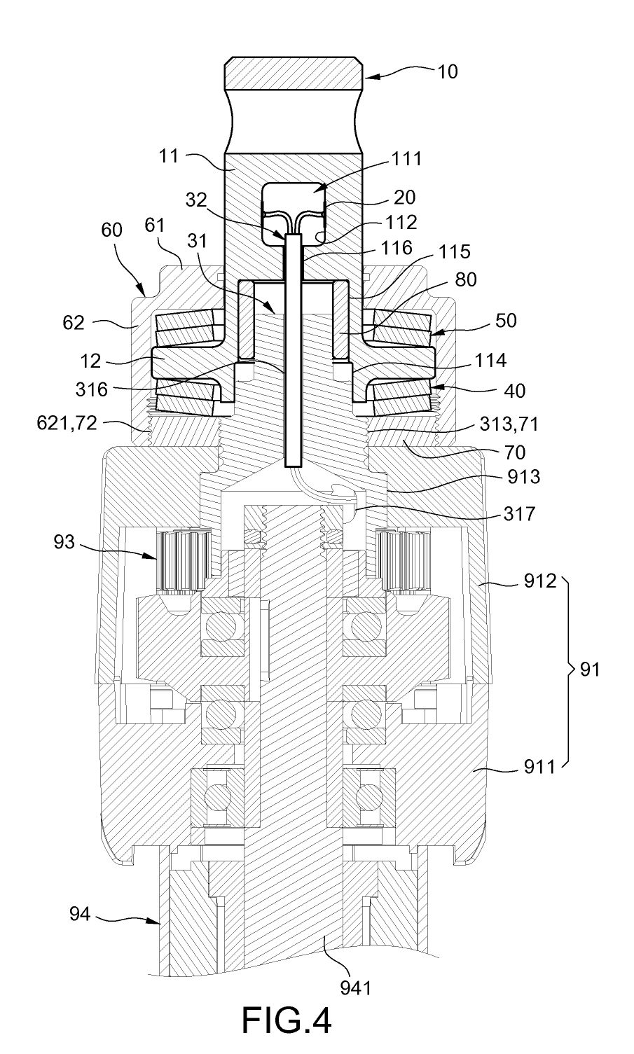

Please refer from FIG. 1 to FIG. 4, the present disclosure provides an electric actuator and an assembly with dual functions of strain sensing and damping mechanism. The electric actuator 9 mainly includes a gear box 91, a motor 92, a deceleration mechanism 93 (as shown in FIG. 4), a transmission mechanism 94, an assembly with dual functions of strain sensing and damping mechanism 1 and other relevant components and devices.

The gear box 91 mainly includes a box body 911 and a cover body 912 correspondingly covering the box body 911. The cover body 912 has a stepped hole 913 (as shown in FIG. 4). The deceleration mechanism 93 is disposed in the gear box 91 and includes a plurality of spur gears with different specifications. The motor 92 and the transmission mechanism 94 are disposed in the box body 911 and connected to the deceleration mechanism 93 for transmissions. The transmission mechanism 94 includes a lead screw 941 (as shown in FIG. 4), a push rod 942 (as shown in FIG. 1) screwed with lead screw 941 for transmissions and other relevant components. Because each of the aforesaid components or mechanisms are well known by skilled people, no further illustration is provided.

According to the present disclosure, the assembly with dual functions of strain sensing and damping mechanism 1 is disposed at one side of the gear box 91 opposite to the transmission mechanism 94. In some embodiments, the assembly with dual functions of strain sensing and damping mechanism 1 is disposed on a top end of the cover body 912, and mainly includes a load body 10, a pair of strain sheets 20, a cable connector 30 and an impact absorbing unit 40.

The load body 10 is a component made of a material such as stainless steel, aluminum or an alloy thereof. The load body 10 has a certain mechanical strength, and mainly includes a columnar member 11 and a flange 12. An opening 111 is disposed at a middle segment of the columnar member 11. The opening 111 is a rectangular slot, and two opposite sides of the opening 111 are formed with a pair of detected surfaces 112.

The columnar member 11 has a penetrated hole 113 located at an upper end relative to the opening 111 to allowing a fastening instrument, a pin or a bolt to penetrate. A polygonal slot hole 114 and a round hole 115 (as shown in FIG. 4) are formed below the opening 111 of the columnar member 11. The round hole 115 is located at an inner side of the polygonal slot hole 114. A communication hole 116 (as shown in FIG. 4) is disposed between the round hole 115 and the opening 111. The flange 12 is extended from a lower segment of the columnar member 11 with a radially expanding manner.

Each of the strain sheets 20 is attached on each of the detected surfaces 113 (as shown in FIG. 4) to sense a deforming level of each of the detected surfaces 113. The strain sheet 20 mainly includes an insulation substrate (not shown in figures) and a metal sensitive grating (not shown in figures). The strain sheet 20 measures a strain of an object. When the object is deformed due to an external force, the metal sensitive grating is also deformed to make a resistance valve thereof generate a corresponding change. Each of the strain sheets 20 is respectively attached on the detected surface 113 via the opening 111, thus each of the strain sheet 112 measures the deforming level of each of the detected surfaces 113. Substantially, a pair of circuit boards (not shown in figures) are provided. Each of the circuit boards are disposed on wall surfaces defined at the other two opposite sides of the opening 111 via the opening 111 and located between each of the strain sheets 20. In other words, each of the strain sheets 20 and each of the circuit boards are perpendicular to each other and staggeringly arranged. One of the circuit boards and one of the strain sheets 20 are electrically connected in series to configure a first half bridge. The other circuit board and the other strain sheet 20 are electrically connected in series to configure a second half bridge. The first half bridge and the second half bridge are electrically connected in series to configure a Wheatstone bridge. As such, a generated varying amount of the resistance valve is measured by the Wheatstone bridge when the object is deformed due to the external force, and the varying amount of the resistance valve is converted into an actual strain value of the object.

The cable connector 30 includes a connection head 31 and a cable 31. The connection head 31 passes the stepped hole 913 and is connected to the columnar member 11. The cable 32 passes the connection head 31 to be electrically connected to each of the strain sheets 20. The connection head 31 is a component made of a material such as stainless steel, aluminum or an alloy thereof. The connection head 31 includes a round shaft segment 311, a polygonal member 312 downwardly extended from the round shaft segment 311, a first outer thread segment 313 downwardly extended from the polygonal member 312, a polygonal segment 314 downwardly extended from the first outer thread segment 313 and a round column 315 downwardly extended from the polygonal segment 314. A central hole 316 (as shown in FIG. 4) is formed at a shaft core of the connection head 31. The polygonal segment 314 has a through hole 317 communicating with the central hole 316.

The cable 32 enters the connection head 31 via the through hole 317, protrudes out of the central hole 316, and then passes the communication hole 116 to be electrically connected to each of the strain sheets 20.

The polygonal member 312 of the connection head 31 is mutually assembled with the polygonal slot hole 114 of the load body 10, thus cable connector 30 and the load body 10 are limited to axially move.

The impact absorbing unit 40 may be defined as a first impact absorbing unit. The impact absorbing unit 40 is disposed on a bottom end surface of the flange 12 and absorbs an impact force applied to the load body 10. The impact absorbing unit 40 may be a disc elastic unit, and an amount thereof may be plural. Each of the impact absorbing units 40 are mutually stacked with each other.

In some embodiments, the assembly with dual functions of strain sensing and damping mechanism 1 of the present disclosure further includes another impact absorbing unit 50. The another impact absorbing unit 50 is disposed on a top end surface of the flange 12, and absorbs the impact force applied to the load body 10. The another impact absorbing unit 50 may be defined as a second impact absorbing unit. The another impact absorbing unit 50 may be a disc elastic unit, and an amount thereof may be plural. Each of the another impact absorbing units 50 are mutually stacked with each other.

In some embodiments, the assembly with dual functions of strain sensing and damping mechanism 1 of the present disclosure further includes an outer housing 60 enclosing the load body 10, each of the impact absorbing units 40 and each of the another impact absorbing units 50. The outer housing 60 includes a top plate 61, an enclosing plate 62 downwardly extended from the top plate 61. Each of the another impact absorbing units 50 is disposed between the top plate 61 and the flange 12.

In some embodiments, the assembly with dual functions of strain sensing and damping mechanism 1 of the present disclosure further includes an adapting ring 70 connected between the connection head 31 and the outer housing 60. The enclosing plate 62 of the outer housing 60 has a first inner thread 621. The adapting ring 70 includes a second inner thread 71 and a second outer thread 72. The second outer thread 72 is mutually threaded and locked with the first inner thread 621 of the outer housing 60. The second inner thread 71 is mutually threaded and locked with the first outer thread segment 313 of the connection head 31. Each of the impact absorbing units 40 is disposed between the adapting ring 70 and the flange 12.

In some embodiments, the assembly with dual functions of strain sensing and damping mechanism 1 of the present disclosure further includes a self-lubricating shaft sleeve 80. The self-lubricating shaft sleeve 80 sheathes the round shaft segment 311 of the connection head 31 and is disposed in the round hole 115 of the load body 10. As such, a lubricating effect is provided when the load body 10 and the connection head 31 axially move to ensure the operation smoothness.

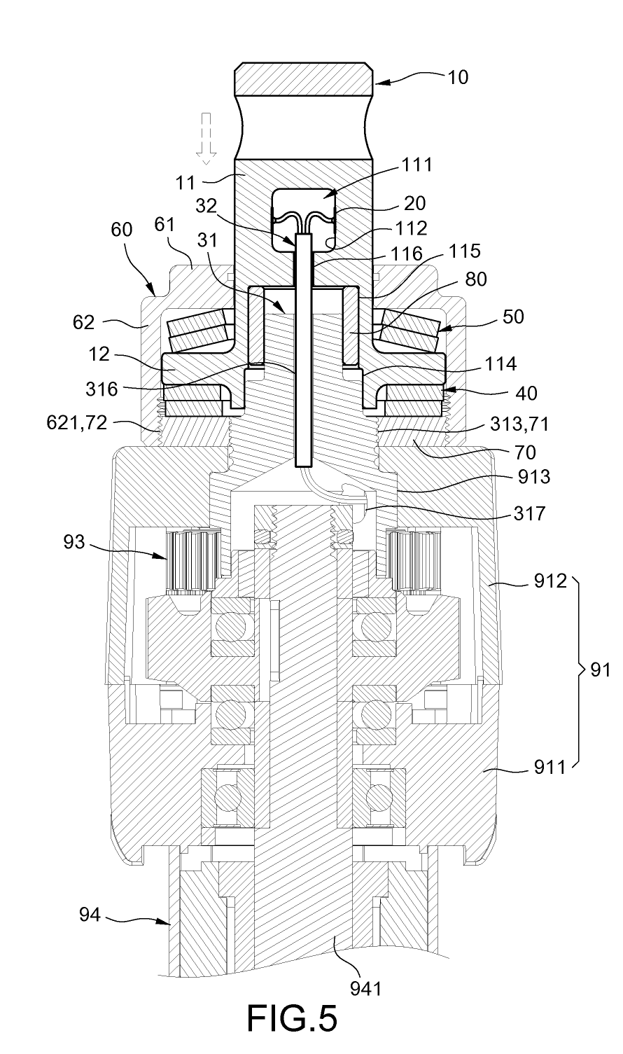

Please refer to FIG. 5, when a push force is applied, the load body 10 generates an axial displacement due to the external push force, the flange 12 of the load body 10 presses each of the impact absorbing units 40, thus a damping effect is provided through each of the impact absorbing units 40. When only the impact absorbing units 40 are provided, the present disclosure is applicable to an electric actuator with a configuration of only generating the pushing motion without any pulling motion.

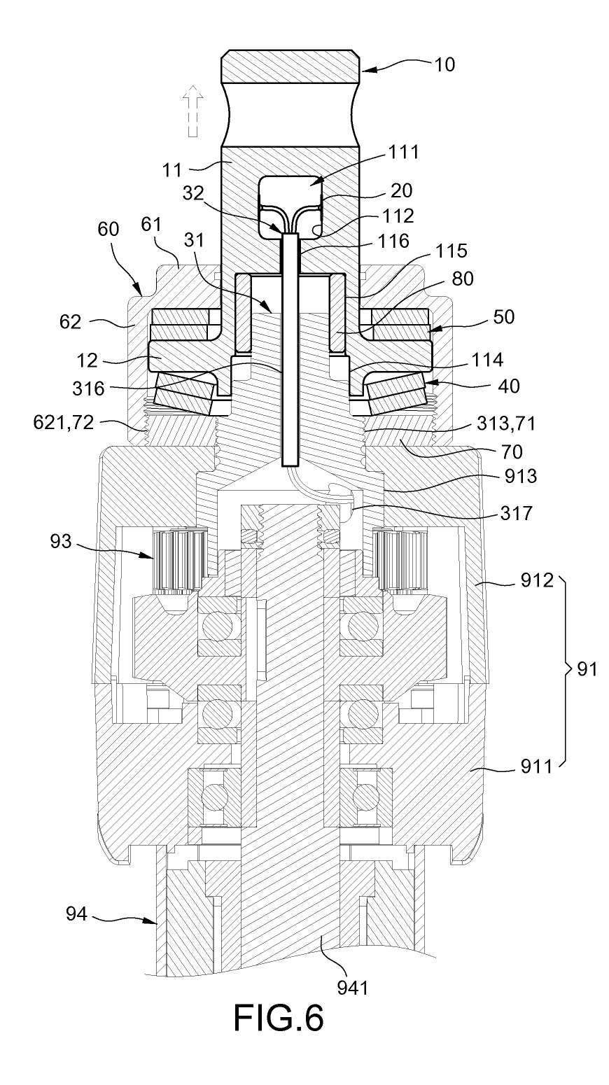

Please refer to FIG. 6, when a pull force is applied, the load body 10 generates an axial displacement due to the external pull force, the flange 12 of the load body 10 presses each of the another impact absorbing units 50, thus a damping effect is provided through each of the another impact absorbing units 50. When both of the impact absorbing units 40 and the another impact absorbing units 50 are provided, the present disclosure is applicable to an electric actuator with various configurations.

While this disclosure has been described by means of specific embodiments, numerous modifications and variations may be made thereto by those skilled in the art without departing from the scope and spirit of this disclosure set forth in the claims.

What is claimed is:

1. An assembly with dual functions of strain sensing and damping mechanism, comprising:
a load body, comprising a columnar member and a flange extended from the columnar body, wherein the columnar member comprises an opening, and a pair of detected surfaces is disposed on two sides of the opening opposite to each other;
a pair of strain sheets, respectively attached on the pair of detected surfaces to sense a deforming level of the pair of detected surfaces;
a cable connector, comprising a connection head and a cable, wherein the connection head is connected to the columnar member, and the cable passes the connection head to be electrically connected to the pair of strain sheets; and
an impact absorbing unit, disposed on one end surface of the flange to absorb an impact force applied to the load body.

2. The assembly with dual functions of strain sensing and damping mechanism according to claim 1, further comprising another impact absorbing unit disposed on another end surface of the flange opposite to the impact absorbing unit to absorb the impact force applied to the load body.

3. The assembly with dual functions of strain sensing and damping mechanism according to claim 2, wherein the impact absorbing unit and the another impact absorbing unit are a disc elastic unit, respectively.

4. The assembly with dual functions of strain sensing and damping mechanism according to claim 2, wherein an amount of the impact absorbing unit and an amount of the another impact absorbing unit are plural.

5. The assembly with dual functions of strain sensing and damping mechanism according to claim 2, further comprising an outer housing covering the load body, the impact absorbing unit and the another impact absorbing unit, wherein the outer housing comprises a top plate and an enclosing plate extended from the top plate, and the another impact absorbing unit is disposed between the top plate and the flange.

6. The assembly with dual functions of strain sensing and damping mechanism according to claim 5, further comprising an adapting ring connected between the connection head and the outer housing, wherein the connector head comprises a first outer thread segment, the enclosing plate comprises a first inner thread, the adapting ring comprises a second inner thread and a second outer thread, the second outer thread is mutually threaded and locked with the first inner thread, the second inner thread is mutually threaded and locked with the first outer thread segment, and the impact absorbing unit is disposed between the adapting ring and the flange.

7. The assembly with dual functions of strain sensing and damping mechanism according to claim 1, further comprising a self-lubricating shaft sleeve, wherein the load body comprises a round hole, the connection head comprises a round shaft segment, and the self-lubricating shaft sleeve sheathes the round shaft segment and is disposed in the round hole.

8. The assembly with dual functions of strain sensing and damping mechanism according to claim 1, wherein the load body comprises a polygonal slot hole, and the connection head comprises a polygonal member mutually assembled with the polygonal slot hole.

9. The assembly with dual functions of strain sensing and damping mechanism according to claim 1, wherein the load body comprises a communication hole, the connection head comprises a round shaft segment, a polygonal member extended from the round shaft segment, a first outer thread segment extended from the polygonal member, a polygonal segment extended from the first outer thread segment and a round column extended from the polygonal segment; a central hole is defined at a shaft core of the connection head, the polygonal segment comprises a through hole communicating with the central hole; the cable enters the connection head via the through hole, protrudes out of the central hole, and passes the communication hole to be electrically connected to the pair of strain sheets.

10. An electric actuator, comprising:
a gear box;
a motor, connected to the gear box;
a transmission mechanism, connected to the gear box and disposed at one lateral side of the motor, wherein the transmission mechanism is driven by the motor; and
an assembly with dual functions of strain sensing and damping mechanism, disposed at one side of the gear box opposite to the transmission mechanism and comprising a load body, a pair of strain sheets, a cable connector and an impact absorbing unit, wherein the load body comprises a columnar member and a flange extended from the columnar body, the columnar member comprises an opening, and a pair of detected surfaces is disposed on two sides of the opening opposite to each other; the pair of strain sheets is attached on the pair of detected surfaces to sense a deforming level of the pair of detected surfaces; the cable connector comprises a connection head and a cable, the connection head is connected to the columnar member, and the cable passes the connection head to be electrically connected to each of the strain sheets; the impact absorbing unit is disposed on one end surface of the flange to absorb an impact force applied to the load body.

11. The electric actuator according to claim 10, wherein the gear box comprises a box body and a cover body correspondingly covering the box body, the cover body comprises a stepped hole, and the connection head passes the stepped hole to be connected to the load body.

12. The electric actuator according to claim 10, wherein the transmission mechanism comprises a lead screw, and the assembly with dual functions of strain sensing and damping mechanism is disposed with a manner of directly facing the lead screw.

13. The electric actuator according to claim 10, wherein the assembly with dual functions of strain sensing and damping mechanism further comprises another impact absorbing unit disposed on another end surface of the flange opposite to the impact absorbing unit to absorb the impact force applied to the load body.

14. The electric actuator according to claim 13, wherein the impact absorbing unit and the another impact absorbing unit are a disc elastic unit, respectively.

15. The electric actuator according to claim 13, wherein an amount of the impact absorbing unit and an amount of the another impact absorbing unit are plural.

16. The electric actuator according to claim 13, wherein the assembly with dual functions of strain sensing and damping mechanism further comprises an outer housing covering the load body, the impact absorbing unit and the another impact absorbing unit, the outer housing comprises a top plate and an enclosing plate extended from the top plate, and the another impact absorbing unit is disposed between the top plate and the flange.

17. The electric actuator according to claim 16, wherein the assembly with dual functions of strain sensing and damping mechanism further comprises an adapting ring connected between the connection head and the outer housing, the connector head comprises a first outer thread segment, the enclosing plate comprises a first inner thread, the adapting ring comprises a second inner thread and a second outer thread, the second outer thread is mutually threaded and locked with the first inner thread, the second inner thread is mutually threaded and locked with the first outer thread segment, and the impact absorbing unit is disposed between the adapting ring and the flange.

18. The electric actuator according to claim 10, wherein the assembly with dual functions of strain sensing and damping mechanism further comprises a self-lubricating shaft sleeve, the load body comprises a round hole, the connection head comprises a round shaft segment, and the self-lubricating shaft sleeve sheathes the round shaft segment and is disposed in the round hole.

19. The electric actuator according to claim 10, wherein the load body comprises a polygonal slot hole, and the connection head comprises a polygonal member mutually assembled with the polygonal slot hole.

20. The electric actuator according to claim 10, wherein the load body comprises a communication hole, the connection head comprises a round shaft segment, a polygonal member extended from the round shaft segment, a first outer thread segment extended from the polygonal member, a polygonal segment extended from the first outer thread segment and a round column extended from the polygonal segment; a central hole is defined at a shaft core of the connection head, the polygonal segment comprises a through hole communicating with the central hole; the cable enters the connection head via the through hole, protrudes out of the central hole, and passes the communication hole to be electrically connected to each of the strain sheets.
